(19) United States
(12) Patent Application Publication
(10) Pub. No.: US 2010/0204353 A1
(43) Pub. Date: Aug. 12, 2010

(54) USE OF NATURAL OIL BASED COMPOUNDS OF LOW FUNCTIONALITY TO ENHANCE FOAMS

(75) Inventor: Francois M. Casati, Pfaffikon (CH)

Correspondence Address: The Dow Chemical Company, P.O. BOX 1967, Midland, MI, 48641, US

(73) Assignee: Dow Global Technologies Inc., Midland, MI (US)

(21) Appl. No.: 12/676,391

(22) PCT Filed: Sep. 4, 2008
(86) PCT No.: PCT/US2008/075208

§ 371 Date: Mar. 4, 2010

Related U.S. Application Data
(60) Provisional application No. 60/967,831, filed on Sep. 7, 2007.

(51) Int. Cl. C08L 75/04

(52) U.S. Cl. 521/137; 525/54.42

(57) ABSTRACT

Isocyanate reactive materials of natural origin having an average isocyanate reactive functionality of less than about 1.5 can be used to enhance polyurethane foams. For instance, use of such materials often results in more open foams than is obtained in the same formulation without the materials. The materials also help maximize the level of renewable resource materials used in foams, especially with viscoelastic foams. The invention includes a polyol composition comprising at least one natural oil isocyanate reactive material having an average isocyanate reactive functionality of less than 1.5 in an amount greater than that naturally present in any natural oil polyol in the composition. While it is preferred to include at least one natural oil polyol in the polyol composition, doing so is optional. The invention additionally includes a process of preparing a polyurethane comprising (a) supplying an isocyanate composition comprising at least one polyisocyanate; (b) supplying at least one polyol composition as previously described; (c) admixing the isocyanate composition and the polyol composition; and (d) exposing the admixture to reaction conditions such that at least one polyurethane is formed.

### CROSS-REFERENCE TO RELATED APPLICATIONS

This application claims benefit of U.S. Provisional Patent Application Ser. No. 60/967,831, filed Sep. 7, 2007, entitled “Use of natural oil based compounds of low functionality to enhance foams” which is herein incorporated by reference.

### BACKGROUND

This invention involves the use of renewable resource materials in polyurethanes, particularly in polyurethane products such as foams. The materials are isocyanate reactive materials having relatively low functionality compared to such materials commonly used in foams.

While some references may acknowledge the possibility of making isocyanate reactive natural oil derivatives of natural oils having lower functionality, it has been taught that natural oil derivatives used in making polyurethanes, especially polyurethane foams should be polyols and have a functionality of at least about 1.5, usually at least about 2. For instance, see such references as WO 2006/116456 (Cargill, Inc.) entitled “Polyurethane Foams Comprising Oligomeric Polyols” where the oligomeric polyol has a minimum functionality around 2.0 and US 2005/0070620 (Herrington) “Flexible Polyurethane Foams prepared using Modified Vegetable Oil-based Polyols” where the polyols have a functionality of at least 2.0. Similarly, U.S. Pat. No. 6,433,121 (Pittsburg State University” “Method of Making Natural Oil-based Polyols and Polyurethane therefrom” teaches polyols having a functionality of at least 2.0. Other references such as WO 2004/099227 (Michigan State University) “Polyol Fatty Acid Polyester Process and Polyurethanes Therefrom” teach use of polyols mainly based on sorbitol hence having a high functionality. WO 2004/096882 (Dow) “Vegetable Oil based Polyols and Polyurethanes made therefrom” and WO 2004/96883 “Polyurethane Foams Made from Hydroxymethyl-Containing Polyester Polyols” (Dow) teach polyols having a functionality of at least 2.0 for making foams. US 2006/0235100 (Bayer) “Polyurethane Foams made with Vegetable Oil Hydroxylate, Polymer Polyol and Aliphatic Polyhydroxy Alcohol” utilizes vegetable oil hydroxylates with an average functionality of at least 1.5. Even specifically in using natural oil polyols to make viscoelastic foams, a hydroxyl functionality of at least about 2 has been taught; see International Patent Application Number PCT/US07/19582, filed Sep. 7, 2007, titled “Viscoelastic Foam Having High Airflow.”

Materials having lower functionality have been considered a problem. For instance, WO 2006/047432 teaches, “One problem is that it has been difficult to regulate the functionality (number of hydroxyl groups/molecule) in these oil-based polyols. Many vegetable oil-based polyols contain a significant fraction of molecules having zero or one isocyanate-reactive group. These molecules either do not react with the polyisocyanate at all, or else act as chain terminators that reduce the polymer molecular weight and crosslink density.”

Since these molecules having an average of fewer than 1.5 isocyanate reactive groups are formed in many processes for making isocyanate reactive monomers, especially polyols, from renewable resources, it would be desirable to use them. Furthermore, it would be desirable to use such molecules to increase the renewable resource content or level of polyurethane products to reduce petroleum dependency. When possible, it would also be desirable to use these molecules in a manner that would improve at least one physical property of a polyurethane product produced using them as compared with the same product produced using the same process and formulation except without the molecules of renewable resource origin having an average of fewer than 1.5 isocyanate reactive groups.

### SUMMARY OF THE INVENTION

It has now been found that contrary to previous teachings, isocyanate reactive materials of natural origin having an average functionality of less than about 1.5, preferably less than about 1.4, more preferably less than about 1.2, most preferably about 1, (hereinafter NOIRM) can be used to enhance polyurethane foams. For instance, use of such NOIRM often results in more open foams than are obtained in the same formulation without the NOIRM. The NOIRM can help maximize the level of renewable resource materials used in foams, especially with viscoelastic foams.

The invention includes a polyol composition comprising at least one NOIRM in an amount greater than that naturally present in any natural oil polyol in the composition. The amount naturally present means the amount present as a result of all the natural oil(s) and process(es) used in preparing the natural oil polyol(s) that are present in the polyol composition without deliberate addition of NOIRM. While it is preferred to include at least one natural oil polyol in the polyol composition, doing so is optional.

The invention additionally includes a process of preparing a polyurethane comprising (a) supplying an isocyanate composition comprising at least one polyisocyanate; (b) supplying at least one polyol composition comprising at least one NOIRM in an amount greater than that naturally present; (c) admixing the isocyanate composition and the polyol composition; and (d) exposing the admixture to reaction conditions such that at least one polyurethane is formed.

### DRAWINGS

There are no drawings

### DETAILED DESCRIPTION OF THE INVENTION

### Definitions

The term “resilience” or “resiliency” is used to refer to the quality of a foam perceived as springiness. It is measured according to the procedures of ASTM D3574 Test H. This ball rebound test measures the height a dropped steel ball of known weight rebounds from the surface of the foam when dropped under specified conditions and expresses the result as a percentage of the original drop height.

The term “ball rebound” is used herein to refer to result of test procedure of ASTM D3574-Test H as previously described.

The term “density” is used herein to refer to weight per unit volume of a foam. Density is determined according to the procedures of ASTM D3574-01, Test A.

The term “core density” is the density measured according to ASTM D3574-95 after removal of any skin that forms on the surface of a molded or free rise foam pad.

The term “CS 75% Parallel-CT” stands for compression set test measured at the 75 percent compressive deformation level and parallel to the rise direction in the foam. This test is used herein to correlate in-service loss of cushion thickness and changes in foam hardness. The compression set is determined according to the procedures of ASTM D 3574-95, Test I. and is measured as percentage of original thickness of the sample. Similarly, “CS 50% Parallel-CT” refers to the same measurement as above (compression set), but this time measured at 50 percent compressive deformation level of the sample, parallel to the rise direction in the foam.

The term “50% HACS” stands for humid aged compression set test measured at the 50 percent of compressive deformation and parallel to the rise direction in the foam. This test is used herein to correlate in-service loss and changes in foam thickness. The 50 percent compression set is determined according to the procedures of DIN 53578 and is measured as percentage of original thickness of the sample. Similarly, “75% HACS” refers to the same measurement (humid aged compression set), but this time measured at 75 percent compressive deformation level of the sample after humid aging.

The term “air flow” refers to the volume of air which passes through a 1.0 inch (2.54 cm) thick 2 inch×2 inch (5.08 cm) square section of foam at 125 Pa (0.018 psi) of pressure. Units are expressed in cubic decimeters per second and converted to standard cubic feet per minute. A representative commercial unit for measuring air flow is manufactured by TexTest AG of Zurich, Switzerland and identified as TexTest Fx3300. This measurement follows ASTM D 3574 Test G.

The term “NCO Index” means isocyanate index, as that term is commonly used in the polyurethane art. As used herein as the equivalents of isocyanate, divided by the total equivalents of isocyanate-reactive hydrogen containing materials, multiplied by 100. Considered in another way, it is the ratio of isocyanate-groups over isocyanate-reactive hydrogen atoms present in a formulation, given as a percentage. Thus, the isocyanate index expresses the percentage of isocyanate actually used in a formulation with respect to the amount of isocyanate theoretically required for reacting with the amount of isocyanate-reactive hydrogen used in a formulation.

As used herein, the term “viscoelasticity” is the time dependent response of a material to an applied constant load (stress) due to the co-existence of elastic (solid) and viscous (liquid) characteristics in the material. This is best observed in creep experiments (akin to the process of a person lying on the bed at night—constant load) in which the rates of deformation varies with time, starting out with an initial instantaneous deformation value (elastic component) and then going through several fast deformation regimes with time (viscoelastic components) and finally reaching a steady strain rate value (liquid component) or zero strain rate value (highly cross linked network materials). In dynamic mechanical characterization, the level of viscoelasticity is proportional to the damping coefficient measured by the tan delta of the material. The tan delta is the ratio of the viscous dissipative loss modulus G″ to the elastic storage modulus G′. High tan delta values imply that there is a high viscous component in the material behavior and hence a strong damping to any perturbation will be observed.

The term “viscoelastic foam” is intended to designate those foams having a resilience of at most 25 percent, as measured according to ASTM D3574 Test H. Resilient foams are those having a resilience of at least 25 percent, and high resilience foams have a resilience above 50 percent. Viscoelastic (VE) foams exhibit a time-delayed and rate-dependent response to an applied stress. In addition to low resiliency they have slow recovery when compressed. In a polyurethane foam, these properties are often associated with the glass transition temperature (T_{g}) of the polyurethane. Viscoelasticity is often manifested when the polymer has a Tg at or near the use temperature, which is room temperature for many applications. Viscoelastic or “memory” foams have a number of very desirable performance characteristics. Viscoelastic foam tends to be low resilience, shape or body conforming, and able to dampen both sound and vibration or shock. A general teaching about viscoelastic foams can be found in US 2005/038133.

As used herein the term “flexible” foam means a foam which recovers upon release from compressive or stretching forces, preferably can be compressed or elongated more than 10% without exceeding its elastic limit. Preferably the foams are sufficiently resilient to compress without damage to the foam structure when a load is applied to the foam. Preferably, a flexible foam will also bounce or spring back to its original size and shape after the load is removed, even after several repetitions of applying and removing a load. This is in contrast to rigid foams that will either not compress without damage to the foam structure when a load is applied to the foam or will not bounce back to their original size and shape after the load has been removed (especially if the load is applied and removed more than once).

As used herein, the term “open celled” means that the individual cells of a foam are interconnected by open channels. Cellular materials, of which foams are an example, are generally defined as two-phase gas-solid systems wherein the solid phase exists as a continuous matrix and the gas-phase occupies pockets dispersed throughout the matrix. The pockets, also known as cells or voids, in one configuration are discrete such that the gas phase within each cell is independent of that present in other cells. Cellular materials having discrete cells are denoted closed-cell foams. Alternatively, in another configuration, the cells are partially or largely interconnected, in which case the system is termed an open-celled foam. Open cells can be measured by airflow. Preferably foams have an airflow of at least 0.6 cfm (cubic foot per minute), more preferably higher than 0.8 cfm and even more preferably higher than 1.0 cfm (0.28, 0.38, 0.47 liters/sec, respectively). Percentage of open cells is measurable by the procedures of ASTM D2856-87.

The term “mold exit time” is used to denote the time when a foaming mass reaches vent holes in a mold.

The term “demold time” or “demolding time” is used to refer to a time when a foam can be demolded substantially without deformation and is, in the manner practiced herein, at least 4 minutes after the mold exit time.

As used herein, “polyol” refers to an organic molecule having an average of greater than 1.0 active hydrogen groups, preferably hydroxyl groups per molecule. It optionally includes other functionalities, that is, other types of functional groups. Preferred among such compounds are materials having at least two hydroxyls, primary or secondary, or at least two amines, primary or secondary, carboxylic acid, or thiol groups per molecule. Compounds having at least two hydroxyl groups or at least two amine groups per molecule are especially preferred due to their desirable reactivity with polyisocyanates, with at least two hydroxyl groups most preferred.

As used herein the term “conventional polyol” or “additional polyol” is used to designate a polyol of other than vegetable or animal origin, preferably of petroleum origin, within the skill in the art for use in polyurethanes or other polymers. The term “conventional polyether polyol” is used for a polyol formed from at least one alkylene oxide, preferably ethylene oxide, propylene oxide or a combination thereof, and not having a part of the molecule derived from a vegetable or animal oil, a polyol of the type commonly used in making polyurethane foams. A polyether polyol can be prepared by known methods such as by alkoxylation of suitable starter molecules. Such a method generally involves reacting an initiator such as, water, ethylene glycol, or propylene glycol, with an alkylene oxide in the presence of a catalyst such as KOH or double cyanide complex (DMC). Ethylene oxide, propylene oxide, butylene oxide, or a combination of these oxides can be particularly useful for the alkoxylation reaction. A polyether polyol, for instance polyoxyethylene polyol can contain alkyl substituents. The process for producing polyether polyols can involve a heterogeneous feed of a mixture of alkylene oxides, a sequential feed of pure or nearly pure alkylene oxide polyols to produce a polyol with blocks of single components, or a polyol which is capped with, for example, ethylene oxide or propylene oxide. These types of polyols preferably having an unsaturation below 0.1 mequiv/g are all known and used in polyurethane chemistry. In addition to polyether polyols, conventional polyols include, for instance, polyester polyols, polycaprolactone polyols or combinations thereof.

The term “natural oil polyol” (hereinafter NOP) is used herein to refer to compounds having hydroxyl groups which compounds are isolated from, derived from or manufactured from natural oils, including animal and vegetable oils, preferably vegetable oils. Examples of vegetable and animal oils that are optionally used include, but are not limited to, soybean oil, safflower oil, linseed oil, corn oil, sunflower oil, olive oil, canola oil, sesame oil, cottonseed oil, palm oil, rapeseed oil, tung oil, fish oil, or a blend of any of these oils. Alternatively, any partially hydrogenated or epoxidized natural oil or genetically modified natural oil can be used to obtain the desired hydroxyl content. Examples of such oils include, but are not limited to, high oleic safflower oil, high oleic soybean oil, high oleic peanut oil, high oleic sunflower oil (such as NuSun sunflower oil), high oleic canola oil, and high erucic rapeseed oil (such as Crumbe oil). Natural oil polyols are well within the knowledge of those skilled in the art, for instance as disclosed in Colvin et al., UTECH Asia, Low Cost Polyols from Natural Oils, Paper 36, 1995 and “Renewable raw materials—an important basis for urethane chemistry:” Urethane Technology: vol. 14, No. 2, April/May 1997, Crain Communications 1997, WO 01/04225, WO 040/96882; WO 040/96883; U.S. Pat. No. 6,686,435, U.S. Pat. No. 6,433,121, U.S. Pat. No. 4,508,853; U.S. Pat. No. 6,107,403, US Pregrant publications 20060041157, and 20040242910.

The term “natural oil based polyol” is used herein to refer to NOP compounds which are derived from natural oils. For instance, natural oils or isolates therefrom are reacted with compounds ranging from air or oxygen to organic compounds including amines and alcohols. Frequently, unsaturation in the natural oil is converted to hydroxyl groups or to a group which can subsequently be reacted with a compound that has hydroxyl groups such that a polyol is obtained. Such reactions within the skill in the art and are discussed in the references in the preceding paragraph.

The term “prepolymer” is used to designate a reaction product of monomers which has remaining reactive functional groups to react with additional monomers to form a polymer.

The term “natural oil based prepolymer” or “natural oil prepolymer” is used herein to describe prepolymers comprising at least one natural oil polyol reacted with at least one monomer reactive therewith in an amount in excess of that amount necessary to form a polymer such that the resulting prepolymer has functional groups remaining that are reactive with hydroxyl groups. For instances, when at least one isocyanate is the reactive monomer, isocyanate prepolymers of natural oil polyols are formed. Forming and using such prepolymers are within the skill in the art such as disclosed by WO 2006/047434 which is incorporated herein by reference to the fullest extent permitted by law.

The term “renewable resource” is used herein to designate animal and plant fats or oils as distinguished from, for instance, petroleum oils and derivatives.

The terms “natural oil content,” “level of renewable resource,” “renewable resource content,” and “level of natural oil” all refer to that weight percentage of the combination of polyols and monomers reactive therewith in a final polymer which has a plant or animal oil or fat as its origin. For instance, if a vegetable oil with a molecular weight of 1000 and having 3 double bonds is fully epoxidized and each ring is opened using a molecule of other than plant or animal oil origin with a molecular weight of 150 to make a triol, which is then reacted with three moles of a petroleum based monomer (for instance, an isocyanate) having an equivalent weight of 333, the level of renewable resource is 1000/(1000+3*17+3*150+3*333)=40 percent. If the same vegetable oil is hydroformylated and reduced to convert the 3 double bonds to hydroxymethyl groups, the calculation is 1000/(1000+3*18+3*333)=48.7 percent.

The term “hydroxyl number” indicates the concentration of hydroxyl moieties in a composition of polymers, particularly polyols. A hydroxyl number represents mg KOH/g of polyol. A hydroxyl number is determined by acetylation with pyridine and acetic anhydride in which the result is obtained as the difference between two titrations with KOH solution. A hydroxyl number is, thus, defined as the weight of KOH in milligrams that will neutralize the acetic anhydride capable of combining by acetylation with 1 gram of a polyol. A higher hydroxyl number indicates a higher concentration of hydroxyl moieties within a composition. Descriptions of methods for determining the hydroxyl number of a composition are well known and found in such texts as Woods, G., The ICI Polyurethanes Book—2nd ed. (ICI Polyurethanes, Netherlands, 1990).

The term “primary hydroxyl group” means a hydroxyl group (—OH) on a carbon atom which has only one other carbon atom attached to it, (preferably which has only hydrogen atoms attached thereto) (—CH₂—OH). A secondary hydroxyl group is on a carbon atom having 2 carbon atoms attached thereto.

The term “functionality” particularly “polyol functionality” is used herein to refer to the number of hydroxyl groups in a polyol.

The term “nominal starter functionality” is used herein to designate the number average functionality (number of hydroxyl groups per molecule) of the polyol or polyol composition on the assumption that this is the number average functionality (number of active hydrogen atoms per molecule) of the raw materials used in its synthesis, typically initiator(s) used in the in the preparation of the polyol(s). The word “average” refers to number average unless indicated otherwise. If a mixed initiator is used, then the nominal functionality of the polyol is the number averaged functionality of the mixed initiator.

The term “VOC” as applied to a polyurethane foam means amounts of volatile organic compounds are released when foam is heated. VOC is measured according to the procedures of VDA 278 (Thermodesorption test) or DIN EN 13419-1 (Chamber test) in milligrams of VOC' s. Desirably the amounts are minimal.

All percentages, preferred amounts or measurements, ranges and endpoints thereof herein are inclusive, that is, “less than about 10” includes about 10. “At least” is, thus, equivalent to “greater than or equal to,” and “at most” is, thus, equivalent “to less than or equal to.” Numbers herein have no more precision than stated. Thus, “115” includes at least from 114.5 to 115.49. Furthermore, all lists are inclusive of combinations of two or more members of the list. All ranges from a parameter described as “at least,” “greater than,” “greater than or equal to” or similarly, to a parameter described as “at most,” “up to,” “less than,” “less than or equal to” or similarly are preferred ranges regardless of the relative degree of preference indicated for each parameter. Thus a range that has an advantageous lower limit combined with a most preferred upper limit is preferred for the practice of this invention. All amounts, ratios, proportions and other measurements are by weight unless stated otherwise. All percentages refer to weight percent based on total composition according to the practice of the invention unless stated otherwise. Except in the examples, or where otherwise indicated, all numbers expressing quantities, percentages, OH numbers, functionalities and so forth in the specification are to be understood as being modified in all instances by the term “about.” Unless stated otherwise or recognized by those skilled in the art as otherwise impossible, steps of processes described herein are optionally carried out in sequences different from the sequence in which the steps are discussed herein. Furthermore, steps optionally occur separately, simultaneously or with overlap in timing. For instance, such steps as heating and admixing are often separate, simultaneous, or partially overlapping in time in the art. Unless stated otherwise, when an element, material, or step capable of causing undesirable effects is present in amounts or in a form such that it does not cause the effect to an unacceptable degree it is considered substantially absent for the practice of this invention. Furthermore, the terms “unacceptable” and “unacceptably” are used to refer to deviation from that which can be commercially useful, otherwise useful in a given situation, or outside predetermined limits, which limits vary with specific situations and applications and can be set by predetermination, such as performance specifications. Those skilled in the art recognize that acceptable limits vary with equipment, conditions, applications, and other variables but can be determined without undue experimentation in each situation where they are applicable. In some instances, variation or deviation in one parameter can be acceptable to achieve another desirable end.

The term “comprising”, is synonymous with “including,” “containing,” or “characterized by,” is inclusive or open-ended and does not exclude additional, unrecited elements, material, or steps. The term “consisting essentially of” indicates that in addition to specified elements, materials, or steps; unrecited elements, materials or steps are optionally present in amounts that do not unacceptably materially affect at least one basic and novel characteristic of the subject matter. The term “consisting of” indicates that only stated elements, materials or steps are present except that unrecited elements, materials or steps may be present to an extent that has no appreciable effect, or are substantially absent.

A polyurethane is typically formed from at least one isocyanate (organic polyisocyanate) and at least one polyol. Materials, methods, catalysts and additives are within the skill in the art.

An organic polyisocyanate is any organic compound or composition having an average of more than 1, preferably an average of at least about 1.8, isocyanate groups per organic molecule. Isocyanates which are optionally used in the present invention include aliphatic, cycloaliphatic, arylaliphatic and aromatic isocyanates. Aromatic isocyanates are preferred.

Examples of suitable aromatic isocyanates include the 4,4′-, 2,4′ and 2,2′-isomers of diphenylmethane diisocyanate (MDI), blends thereof and polymeric and monomeric MDI blends, toluene-2,4- and 2,6-diisocyanates (TDI), m- and p-phenylenediisocyanate, chlorophenylene-2,4-diisocyanate, diphenylene-4,4′-diisocyanate, 4,4′-diisocyanate-3,3′-dimethyldiphenyl, 3-methyldiphenyl-methane-4,4′-diisocyanate and diphenyletherdiisocyanate and 2,4,6-triisocyanatotoluene and 2,4,4′-triisocyanatodiphenylether.

Mixtures of isocyanates are optionally used, such as the commercially available mixtures of 2,4- and 2,6-isomers of toluene diisocyanates. A crude polyisocyanate is optionally used in the practice of this invention, such as crude toluene diisocyanate obtained by the phosgenation of a mixture of toluene diamine or the crude diphenylmethane diisocyanate obtained by the phosgenation of crude methylene diphenylamine. TDI/MDI blends are optionally used. MDI or TDI based prepolymers are optionally used. In the practice of the invention, a prepolymer is made using at least one natural oil or conventional polyol, and at least one NOIRM or a combination thereof or is made with at least one natural or conventional polyol and reacted with a polyol composition comprising at least one NOIRM. Isocyanate-terminated prepolymers are prepared by reacting an excess of polyisocyanate with at least one polyol, for instance at least one aminated polyol or imines/enamine thereof, or polyamine.

Examples of aliphatic polyisocyanates include ethylene diisocyanate, 1,6-hexamethylene diisocyanate, isophorone diisocyanate, cyclohexane 1,4-diisocyanate, 4,4′-dicyclohexylmethane diisocyanate, saturated analogues of the above mentioned aromatic isocyanates and mixtures thereof.

For the production of flexible foams, the preferred polyisocyanates are the toluene-2,4- and 2,6-diisocyanates or MDI or combinations of TDI/MDI or prepolymers made therefrom.

The amount of polyisocyanate used in making a flexible foam is commonly expressed in terms of isocyanate index, that is, 100 times the ratio of NCO groups to reactive hydrogens-contained in the reaction mixture. In the production of conventional slabstock foam, the isocyanate index often ranges from about 75 to about 140, especially from about 80 to about 115. In molded and high resiliency slabstock foam, the isocyanate index often ranges from about 50 to about 150, especially from about 75 to about 110. Thus, in the practice of the invention the isocyanate index is advantageously at least about 60, more advantageously at least about 70, preferably at least about 80, more preferably at least about 90, and independently advantageously at most about 150, more advantageously at most about 130, preferably at most about 120, more preferably at most about 115, most preferably at most about 110.

The isocyanate is reacted with at least one polyol which can be either at least one conventional polyol or at least one natural oil polyol as well as with the NOIRM according to the practice of the invention.

Conventional polyols include any polyol or combination thereof not of animal or vegetable origin, that is, usually of petroleum origin, and having a hydroxyl functionality of greater than 1.5, preferably at least about 1.8, more preferably at least about 2, defined as “conventional polyols.” Such conventional polyols are well known in the art and include those described herein and any other commercially available polyol and/or SAN, PIPA or PHD copolymer polyols. Such polyols are described in “Polyurethane Handbook”, by G. Oertel, Hanser publishers. Mixtures of one or more such polyols, one or more copolymer polyols or a combination thereof are optionally used to produce polyurethane products according to the practice of the present invention.

Representative polyols include polyether polyols, polyester polyols, polyhydroxy-terminated acetal resins, hydroxyl-terminated amines and polyamines. Examples of these and other suitable isocyanate-reactive materials are described more fully in U.S. Pat. No. 4,394,491. Alternative polyols that are optionally used include polyalkylene carbonate-based polyols and polyphosphate-based polyols. Preferred are polyols prepared by adding an alkylene oxide, such as ethylene oxide, propylene oxide, butylene oxide or a combination thereof, to an initiator having from 2 to 8, preferably 2 to 6 active hydrogen atoms. Catalysis for this polymerization can be either anionic or cationic, with catalysts such as KOH, CsOH, boron trifluoride, or a double cyanide complex (DMC) catalyst such as zinc hexacyanocobaltate or quaternary phosphazenium compound.

Examples of suitable initiator molecules are water, organic dicarboxylic acids, such as succinic acid, adipic acid, phthalic acid and terephthalic acid; and polyhydric, in particular dihydric to octohydric alcohols or dialkylene glycols.

Exemplary polyol initiators include, for example, ethanediol, 1,2- and 1,3-propanediol, diethylene glycol, dipropylene glycol, 1,4-butanediol, 1,6-hexanediol, glycerol, pentaerythritol, sorbitol, sucrose, neopentylglycol; 1,2-propylene glycol; trimethylolpropane glycerol; 1,6-hexanediol; 2,5-hexanediol; 1,4-butanediol; 1,4-cyclohexane diol; ethylene glycol; diethylene glycol; triethylene glycol; 9(1)-hydroxymethyloctadecanol, 1,4-bishydroxymethylcyclohexane; 8,8-bis(hydroxymethyl)tricyclo[5,2,1,0^{2,6}]decene; dimerol alcohol (36 carbon diol available from Henkel Corporation); hydrogenated bisphenol; 9,9(10,10)-bishydroxymethyloctadecanol; 1,2,6-hexanetriol; and combination thereof.

Of particular interest are poly(propylene oxide) homopolymers, random copolymers of propylene oxide and ethylene oxide in which the poly(ethylene oxide) content is, for example, from about 1 to about 30 percent by weight, ethylene oxide-capped poly(propylene oxide) polymers and ethylene oxide-capped random copolymers of propylene oxide and ethylene oxide. For slabstock foam applications, such polyethers preferably contain at least about 2 and independently preferably at most about 8, more preferably at most about 6, and most preferably at most about 4, predominately (greater than 50 percent) secondary (but also some primary) hydroxyl groups per molecule and have an equivalent weight per hydroxyl group of from preferably at least about 400, more preferably at least about 800 to preferably at most about 3000, more preferably at most about 1750. For high resiliency slabstock and molded foam applications, that is, having ball rebound of at least 40 percent, such polyethers preferably contain at least about 2 and independently preferably at most about 6, more preferably at most about 5; and most preferably in each instance predominately primary hydroxyl groups per molecule and have an equivalent weight per hydroxyl group of preferably from at least about 1000, more preferably at least about 1200 to preferably at most about 3000, more preferably at most about 2000.

When blends of polyols are used, the nominal average functionality (number of hydroxyl groups per molecule) preferably are in the ranges specified above.

For viscoelastic foams shorter chain polyols with hydroxyl numbers preferably above about 150 are optionally used alone or in combination with a lower hydroxyl.

The polyether polyols optionally contain low terminal unsaturation (for example, less than about 0.02 meq/g or less than about 0.01 meq/g), such as those made using so-called double metal cyanide (DMC) catalysts, as described for example in U.S. Pat. Nos. 3,278,457, 3,278,458, 3,278,459, 3,404,109, 3,427,256, 3,427,334, 3,427,335, 5,470,813 and 5,627,120. Polyester polyols often contain about 2 hydroxyl groups per molecule and have an equivalent weight per hydroxyl group of about 400-1500. Polymer polyols of various types are optionally used as well. Polymer polyols include dispersions of polymer particles, such as polyurea, polyurethane-urea, polystyrene, polyacrylonitrile and polystyrene-co-acrylonitrile polymer particles in a polyol, typically a polyether polyol. Suitable polymer polyols include all within the skill in the art, for instance those described in U.S. Pat. Nos. 4,581,418 and 4,574,137.

Overall conventional polyols preferably have at least about 2 and independently preferably at most about 8, more preferably at most about 6, and most preferably at most about 4, primary or secondary or a combination thereof hydroxyl groups per molecule and have a hydroxyl number of preferably at least about 15, more preferably at least about 32, most preferably at least about 45, optionally and independently to preferably at most about 200, more preferably at most about 180, most preferably at most about 170. The viscosity of the conventional polyol measured at 25° C. is advantageously less than about 10,000 mPa·s, preferably less than about 8,000.

Alternatively to, or in combination with at least one conventional polyol, at least one natural oil polyol is used.

Natural oil polyols are polyols based on or derived from renewable resources such as natural and/or genetically modified (GMO) plant vegetable seed oils and/or animal source fats. Such oils and/or fats are generally comprised of triglycerides, that is, fatty acids linked together with glycerol. Preferred are vegetable oils that have at least about 70 percent unsaturated fatty acids in the triglyceride. Preferably the natural product contains at least about 85 percent by weight unsaturated fatty acids. Examples of preferred vegetable oils include, for example, those from castor, soybean, olive, peanut, rapeseed, corn, sesame, cotton, canola, safflower, linseed, palm, sunflower seed oils, or a combination thereof. Examples of animal products include lard, beef tallow, fish oils and mixtures thereof. A combination of vegetable and animal based oils/fats is optionally used. The iodine value of these natural oils range from about 40 to 240. Preferably natural oil polyols are derived from soybean and/or castor and/or canola oils.

For use in the production of flexible polyurethane foam it is generally desirable to modify the natural materials to give the material isocyanate reactive groups or to increase the number of isocyanate reactive groups on the material. Preferably such reactive groups are a hydroxyl group. Several chemistries can be used to prepare the natural oil polyols. Such modifications of a renewable resource include, for example, epoxidation, as described in U.S. Pat. No. 6,107,433 or in U.S. Pat. No. 6,121,398; hydroxylation, such as described in WO 2003/029182; esterification such as described in U.S. Pat. No. 6,897,283; 6,962,636 or 6,979,477; hydroformylation as described in WO 2004/096744; grafting such as described in U.S. Pat. No. 4,640,801; or alkoxylation as described in U.S. Pat. No. 4,534,907 or in WO 2004/020497. These cited references for modifying the natural products are incorporated herein by reference to the fullest extent permitted by law. Other natural oil polyols suitable for practice of the invention include those disclosed in such references as Grosch, G. H. et. al., WO0014045(A1) (Mar. 16, 2000); David M. Casper, US20060041155(A1), Aug. 23, 2004; David M. Casper and Trevor Newbold, US20060041156(A1); Ashvin Shah and Tilak Shah, WO 0104225(A1), (Jul. 12, 2000), Ron Herrington and Jeffrey Malsam, US20050070620(A1), (Jun. 25, 2004). Dwight E. Peerman and Edgar R. Rogier, EP106491 (Sep. 6, 1983); U.S. Pat. No. 4,496,487 (Sep. 7, 1982); U.S. Pat. No. 4,423,162 (Dec. 27, 1983); and U.S. Pat. No. 4,543,369 (Oct. 26, 1984); Zoran S. Petrovic et al. all of which are incorporated herein by reference to the fullest extent permitted by law. After the production of such polyols by modification of the natural oils, the modified products are optionally further alkoxylated. The use of ethylene oxide (EO) or mixtures of EO with other oxides, introduce hydrophilic moieties into the polyol. In one embodiment, the modified product undergoes alkoxylation with sufficient EO to produce a natural oil polyol with preferably at least about 10, more preferably at least about 20 to preferably at most about 60, more preferably at most about 40 weight percent EO.

In another embodiment, preferred natural oil polyols are those disclosed in PCT Publications WO 2004/096882 and 2004/096883, and copending PCT Publication WO2006/118995 entitled “Polyester Polyols Containing Secondary Alcohol Groups and Their Use in Making Polyurethanes Such as Flexible Polyurethane Foams,” the disclosures of which represent skill in the art and are incorporated herein by reference to the fullest extent permitted by law. Polyols disclosed in WO 04/096882 and WO 04/096883 are most preferred. These are the reaction products of initiators having active hydrogen such as a polyol or polyamine, amino alcohol or mixture thereof with a vegetable oil based monomer prepared by such processes as hydroformylation of unsaturated fatty acids or esters, followed by hydrogenation of at least a portion of the resulting formyl groups. Such a polyol is referred to hereinafter as “initiated fatty acid polyester alcohol.” Among these, more preferred polyols include those initiated with alkoxylated, preferably ethoxylated, polyhydroxyl compounds, preferably glycerin, sucrose, or combinations thereof, and having a molecular weight of advantageously at least about 400, more preferably at least about 600 and preferably at most about 1000, more preferably at most about 800. In an alternative embodiment, the polyols taught in WO2006/118995, referred to herein as “initiated secondary hydroxyl fatty acid copolyesters” are most preferred. These are the reaction products of initiators such as those used in making the initiated fatty acid polyester alcohols with a vegetable oil based monomer or oligomer which naturally has secondary hydroxyl groups, such as ricinoleic acid or into which secondary hydroxyl groups have been introduced by such processes as reacting water across a double bond for instance as taught in such references as U.S. Pat. No. 6,018,063 and by Isbell et al., J. Amer. Oil Chem. Soc., 71 (4) 379 (1994); reacting an unsaturated fatty acid or ester with formic acid as taught for instance in U.S. Pat. No. 2,759,953, oxidation of fatty acids or esters for instance as taught by John et al., J. Appl. Polym. Sci. 86, 3097 (2002) and Swern et al., JACS, 67, 1134 (1945), by epoxidation and ring opening and the like. Thus, a natural oil polyol or combination thereof optionally has primary, secondary or a combination thereof hydroxyl groups. Both types of most preferred polyols are favored, in part, because either can optionally include polyols with both hydrophobic and hydrophilic moieties. The hydrophobic moiety is provided by the natural oils since those contain C4 to C24 saturated and/or unsaturated chain lengths, preferably C4 to C18 chain lengths, while the hydrophilic moiety is obtained by the use of hydrophilic polyol chains present on the initiator, such as those containing high levels of ethylene oxide.

Preferably the initiator is selected from the group consisting of neopentylglycol; 1,2-propylene glycol; trimethylolpropane; pentaerythritol; sorbitol; sucrose; glycerol; diethanolamine; alkanediols such as 1,6-hexanediol, 1,4-butanediol; 1,4-cyclohexane diol; 2,5-hexanediol; ethylene glycol; diethylene glycol, triethylene glycol; bis-3-aminopropyl methylamine; ethylene diamine; diethylene triamine; 3,3′-diamino-N-methyldipropylenediamine, 9(1)-hydroxymethyloctadecanol, 1,4-bishydroxymethylcyclohexane; 8,8-bis(hydroxymethyl)tricyclo[5,2,1,0^{2,6}]decene; Dimerol alcohol; hydrogenated bisphenol; 9,9(10,10)-bishydroxymethyloctadecanol; 1,2,6-hexanetriol and combination thereof. More preferably the initiator is selected from the group consisting of glycerol; ethylene glycol; 1,2-propylene glycol; trimethylolpropane; ethylene diamine; pentaerythritol; diethylene triamine; sorbitol; sucrose; or any of the aforementioned where at least one of the alcohol or amine groups present therein has been reacted with ethylene oxide, propylene oxide or mixture thereof; and combination thereof. Most preferably the initiator is glycerol, trimethylopropane, pentaerythritol, sucrose, sorbitol, 3,3′-diamino-N-methyldipropylenediamine, or a combination thereof.

In one preferred embodiment, such initiators are alkoxylated with ethylene oxide or a mixture of ethylene and at least one other alkylene oxide to give an alkoxylated initiator with a molecular weight of 200 to 6000, especially from 400 to 2000. Preferably the alkoxylated initiator has a molecular weight from 500 to 1000. In another embodiment, at least one natural oil polyol contains a high EO (ethylene oxide) based moiety. In one embodiment, at least one natural oil polyol preferably contains at least about 10 weight percent ethylene oxide, that is, has at least about 10 weight percent molecular structures derived from ethylene oxide (EO). More preferably at least one natural oil polyol is prepared from at least about 15, most preferably at least about 20 weight percent EO. Independently, preferably at least one natural oil polyol contains at most about 60, more preferably at most about 50, most preferably at most about 40 weight percent ethylene oxide.

Preferably, the functionality of the natural oil polyol, or blend of such polyols, is at least about 1.5, more preferably at least about 1.8, most preferably at least about 2.0 and independently preferably at most about 6, more preferably at most about 5, most preferably the functionality is at most about 4. The hydroxyl number of at least one natural oil polyol, or blend of such polyols, is preferably at most about 300 mg KOH/g, more preferably at most about 200, most preferably at most about 100 mg KOH/g. The viscosity of the natural oil polyol measured at 25° C. is advantageously less than about 10,000 mPa·s, preferably less than about 8,000 mPa·s.

The natural oil polyol is optionally any combination of two or more natural oil polyols. When more than one natural oil polyol is used, two or more are optionally of the same type or, in another embodiment, are of different types, for instance as disclosed in International Patent Application Number PCT/US08/71048, filed Jul. 24, 2008, titled “Polyol Blends For Use In Making Polymers.” Combinations often are useful to maximize the level of seed oil in the foam formulation, or to optimize foam processing and/or specific foam characteristics, such as resistance to humid aging. In this embodiment, the natural oil polyol component comprises at least two different natural oil polyols wherein the differences are in at least one of (a) processes by which they are made, or (b) molecular structures sufficiently different to result in improved physical or processing properties, satisfactory properties at a higher level of renewable resources (more preferably at least about 2 weight percent higher) or when using a larger amount of combined natural oil polyols in a resulting polymeric product or a combination thereof, all as compared with essentially the same end product produced by essentially the same process but using one of the natural oil polyols alone in an amount equal to that of the combination of natural oil polyols. Independently preferably, the processes differ by at least one of reaction temperature, reaction time, reaction pressure or a combination thereof, preferably by more than one of reaction temperature, reaction time, reaction pressure, catalyst, at least, more preferably by at least one unit operation, or a combination thereof, more preferably wherein at least the first process involves at least one unit operation of hydroformylation, epoxidation, alkoxylation, esterification, transesterification, alcoholysis, oxidation, ring opening using a natural oil or derivative thereof while the second process does not involve at least one of the listed unit operations used in preparing the first polyol or involves at least one additional unit operation or, a combination of both, most preferably wherein at least two natural oil polyols represent different members of the group consisting of triethanolamine alcoholyzed peroxy acid hydroxylate, epoxidized vegetable oil at least partially ring opened to produce a secondary hydroxyl group on a main vegetable oil chain, hydroformylated vegetable oil where the formyl groups have been at least partially converted to hydroxymethyl groups; air blown vegetable oil (not alkoxylated or further treated), alkoxylated air blown vegetable oil, transesterified air blown oil; fatty acid alcohol alkoxylates; transesterified vegetable oil, alkoxylated vegetable oil; alkoxylated polyester polyol, polyester polyol, polyetherpolyester polyol, initiated fatty acid polyester alcohol; epoxy ring-opening oligomer, and natural polyol. The two polyols independently preferably differ by at least one of the following: percentage of hydroxyl groups that are primary as compared to secondary; hydroxyl functionality; molecular weight; hydrophilicity (level of ethylene oxide); or natural oil raw material. More preferably (a) at least one of the different natural oil polyols has at least about 50, percent of its hydroxyl groups as primary while at least one different natural oil polyol has at least about 51, percent of its hydroxyl groups as secondary; (b) the polyols differ in hydroxyl functionality by at least about 10 percent; (c) have molecular weights differing by at least about 10 percent; (d) differ in hydrophilicity, by at least about 10 percent in level of ethylene oxide incorporated into the polyol molecules; (e) differ in originating from different natural oil raw materials, (f) differ in having a difference in fatty acid distribution as reflected in at least about a 10 weight percent difference in the level of any fatty acid or ester; or a combination thereof. Most preferably at least one of the natural oil polyols is at least one initiated fatty acid polyester alcohol. Independently, most preferably at least one natural oil polyol comprises at least one natural oil polyol which has been oxidized or epoxidized in some stage of its preparation. In a preferred embodiment at least one of the different natural oil polyols is an initiated fatty acid polyester alcohol, while at least one different natural oil polyol has been oxidized or epoxidized.

In the practice of the invention, at least one isocyanate reactive materials of natural origin having an average functionality of preferably less than 1.5, preferably less than about 1.4, more preferably less than about 1.2, most preferably about 1, (NOIRM) is used in combination with at least one polyol, whether it be conventional (petroleum based) polyol or natural oil polyol or a combination thereof.

NOIRM are individual compounds, such as 9,(10)-hydroxymethylstearate (for instance, made from methyl oleate); a mixture of compounds of natural origin as obtained from natural oils or fats, preferably seed oils or derivatives thereof; purified monols extracted or otherwise concentrated from such a mixture; polymers made by reacting any of these types of monols, preferably a single compound such as hydroxymethylstearate, (for instance by homopolymerization through their ester and hydroxyl moieties); or a combination thereof. In each instance, NOIRM have an average functionality close to one as previously discussed. NOIRM include, for instance, fatty acids and their esters obtained from natural oils, purified monols, homopolymers and combinations thereof.

NOIRM are suitably prepared by any means within the skill in the art. In one preferred embodiment, they are obtained by saponification of natural oils, for instance by methods such as those taught in WO 2004/096744 starting either from vegetable oil based fatty acid methyl esters, or from individual esters such as methyl oleate. They are also conveniently prepared by such processes such as distillation, extraction or other means such as that disclosed in U.S. Patent Application No. 60/958,473, titled “Purification of Hydroformylated and Hydrogenated Fatty Alkyl Ester Compositions”, filed Jul. 6, 2007, which is incorporated by reference herein to the extent permitted by law.

Alternatively, polymers are formed from, preferably, individual compounds such as hydroxymethylstearate or similar esters or, alternatively, from mixtures of such compounds, for instance by transesterification as is well within the skill in the art, such as taught by such references as WO2004/096882, except using monofunctional initiators or allowing the monomers to be self initiating. Useful initiators include monofunctional alcohols and amines, for instance, methanol, ethanol, butanol, dicyclohexylamine or combinations thereof. WO2004/096882 is incorporated herein by reference to the extent permitted by law. Inclusion of monomers of petroleum origin in the polymers is within the scope of the invention, thus the polymers are formed from monomer compositions comprising at least one initiator and at least one NOIRM.

NOIRM used in the practice of the invention have an average molecular weight of preferably at least about 100, more preferably at least about 200, most preferably at least about 250, and preferably at most about 1,500, more preferably at most about 1,200, most preferably at most about 1,000. When the NOIRM is a mixture, each component of the mixture has a molecular weight of preferably at least about 100, more preferably at least about 200, most preferably at least about 250, and preferably at most about 1,500, more preferably at most about 1,200, most preferably at most about 1,000. NOIRM used in the practice of the invention have an average isocyanate reactive equivalent weight of preferably at least about 100, more preferably at least about 200, most preferably at least about 250, and preferably at most about 1,500, more preferably at most about 1,200, most preferably at most about 1,000. It is within the scope of the invention to use the NOIRM with monols of petroleum origin having the same ranges of preferred average and component molecular and equivalent weights.

In the practice of the invention, at least one NOIRM is used with at least one polyol to react with at least one isocyanate to form a polyurethane. The amount of NOIRM is advantageously at least about 1, more advantageously at least about 2, preferably at least about 3, more preferably at least about 4, most preferably at least about 5 and advantageously at most about 60, preferably at most about 50, more preferably at most about 40, most preferably at most about 30 parts per hundred parts by weight of total polyol where the NOIRM is counted as part of the polyol composition.

While use of conventional polyol or a combination thereof is optional in the practice of the invention, thus can be present in an amount of 0 weight percent, it is preferably present in an amount of at least about 10, more preferably at least about 15, most preferably at least about 20; optionally to preferably at most about 90, more preferably at most about 80, most preferably at most about 70 weight percent based on total polyol weight.

The natural oil polyol or blend thereof constitutes from 0 to 99 weight percent of polyol formulation. At least one natural oil polyol constitutes advantageously at least about 2, more advantageously at least about 5, preferably at least about 10, more preferably at least about 15, most preferably at least about 20 weight percent of the total weight of the polyol components present, preferably with a content of at least 10 percent renewable resources (that is, coming from the seed oil and/or other plants or animals) based on the total polyol blend. Alternatively, natural oil polyols or a combination thereof advantageously constitute at most about 99, more advantageously at most about 95, preferably at most about 92, more preferably at most about 90 weight percent of the total weight of the polyol.

One or more crosslinkers are optionally present in the flexible foam formulation, in addition to the polyols described above. This is particularly the case when making high resilience slabstock or molded foam. If used, amounts of crosslinkers used are preferably at least about 0.1, more preferably at least about 0.25, and preferably at most about 1, more preferably at most about 0.5 part by weight, per 100 parts by weight of total polyols.

For purposes of this invention “crosslinkers” are materials having three or more isocyanate-reactive groups per molecule and preferably an equivalent weight per isocyanate-reactive group of less than about 400. Crosslinkers preferably have at least about 3 and preferably at most about 8, more preferably about 4 hydroxyl, primary amine or secondary amine groups per molecule and have an equivalent weight of preferably at least about 30, more preferably at least about 50 and, independently preferably at most about 200, more preferably at most about 125. Examples of suitable crosslinkers include diethanol amine, monoethanol amine, triethanol amine, mono- di- or tri(isopropanol) amine, glycerine, trimethylol propane, pentaerythritol, sorbitol and the like.

It is also possible to use one or more chain extenders in the foam formulation. For purposes of this invention, a chain extender is a material having two isocyanate-reactive groups per molecule and an equivalent weight per isocyanate-reactive group of preferably less than about 400, preferably at least about 31 and more preferably at most about 125. The isocyanate reactive groups are preferably hydroxyl, primary aliphatic or aromatic amine or secondary aliphatic or aromatic amine groups. Representative chain extenders include amines ethylene glycol, diethylene glycol, 1,2-propylene glycol, dipropylene glycol, tripropylene glycol, ethylene diamine, phenylene diamine, bis(3-chloro-4-aminophenyl)methane and 2,4-diamino-3,5-diethyl toluene. If used, chain extenders are typically present in an amount of preferably at least about 1, more preferably at least about 3 and, independently preferably at most about 50, more preferably at most about 25 parts by weight per 100 parts by weight high equivalent weight polyol.

The use of such crosslinkers and chain extenders is known in the art as disclosed in U.S. Pat. No. 4,863,979 and EP Publication 0 549 120.

In the present invention, a polyether polyol is optionally included in the formulation, to promote the formation of an open-celled or softened polyurethane foam. Such cell openers are disclosed in U.S. Pat. No. 4,863,976, the disclosure of which is incorporated here by reference. Such cell openers generally have a functionality of at least about 2, preferably at least about 3 and preferably at most about 12, more preferably at most about 8, and a molecular weight of at least 5,000 up to about 100,000. Such polyether polyols contains at least 50 weight percent oxyethylene units, and sufficient oxypropylene units to render them compatible with other components of the foam formulation. The cell openers, when used, are preferably present in an amount of at least about 0.2 and preferably at most about 5, more preferably at most about 3 parts by weight of the total polyol. Examples of commercially available cell openers are VORANOL*Polyol CP 1421 and VORANOL*Polyol 4053 (this polyol has a functionality of 6 since it is sorbitol initiated); VORANOL is a trademark of The Dow Chemical Company.

To produce a polyurethane foam, a blowing agent is required. In the production of flexible polyurethane foams, water is preferred as a blowing agent in most instances. The amount of water is preferably at least about 0.5, more preferably at least about 2, and independently preferably at most about 10, more preferably at most about 7 parts by weight based on 100 parts by weight of the total polyol. Other blowing agents and their use are well within the skill in the art. For instance, carboxylic acids or salts are optionally used as reactive blowing agents. Other blowing agents include liquid or gaseous carbon dioxide, methylene chloride, acetone, pentane, isopentane, methylal or dimethoxymethane, dimethylcarbonate. Use of artificially reduced or increased atmospheric pressure, as described in U.S. Pat. No. 5,194,453, is also contemplated in the practice of the present invention. A foam is optionally blown with any one or any combination of such agents or means.

In addition to the foregoing components, it is often desirable to employ certain other ingredients in preparing polyurethane polymers. Among these additional ingredients are emulsifiers, silicone surfactants, preservatives, flame retardants, colorants, antioxidants, reinforcing agents, fillers, including recycled polyurethane foam in form of powder, or a combination of these with or without other additives.

One or more catalysts for the reaction of the polyol composition and, optionally, water with the polyisocyanate are used. Exemplary organometallic catalysts include organomercury, organolead, organoferric, organotin, organobismuth, organolithium, and combinations thereof. Other catalysts include nitrogen-containing compounds. It is frequently useful to combine at least one organometallic compound with at least one nitrogen-containing catalyst, preferably at least one tertiary amine.

Nitrogen-containing catalysts include tertiary amine compounds, amines with isocyanate reactive groups and organometallic compounds. Exemplary tertiary amine compounds include triethylenediamine, N-methylmorpholine, N,N-dimethylcyclohexylamine, pentamethyldiethylenetriamine, tetramethylethylenediamine, bis(dimethylaminoethyl)ether, 1-methyl-4-dimethylaminoethyl-piperazine, 3-methoxy-N-dimethylpropylamine, N-ethylmorpholine, dimethylethanolamine, N-cocomorpholine, N,N-dimethyl-N′,N′-dimethyl isopropylpropylenediamine, N,N-diethyl-3-diethylamino-propylamine, dimethylbenzylamine and combinations thereof.

Processing for producing polyurethane products are well known in the art. In general components of the polyurethane-forming reaction mixture may be mixed together in any convenient manner, for example by using any of the mixing equipment and process described in the prior art for the purpose such as described in “Polyurethane Handbook”, by G. Oertel, Hanser publisher.

In general, the polyurethane foam is prepared by mixing the polyisocyanate and polyol composition in the presence of at least one blowing agent, at least one catalyst and other optional ingredients as desired, under conditions such that the polyisocyanate and polyol composition react to form a polyurethane and/or polyurea polymer while the blowing agent generates a gas that expands the reacting mixture. The foam is optionally formed by the so-called prepolymer method, as described in U.S. Pat. No. 4,390,645, for example, in which a stoichiometric excess of the polyisocyanate is first reacted with the high equivalent weight polyol(s) to form a prepolymer, which is in a second step reacted with a chain extender and/or water to form the desired foam. Frothing methods, as described in U.S. Pat. Nos. 3,755,212; 3,849,156 and 3,821,130, for example, are also suitable. So-called one-shot methods, such as described in U.S. Pat. No. 2,866,744, are preferred. In such one-shot methods, the polyisocyanate and all polyisocyanate-reactive components are simultaneously brought together and caused to react. Three widely used one-shot methods, which are among the methods suitable for use in this invention, include conventional slabstock foam processes, high resiliency slabstock foam processes, viscoelastic foam slabstock process and molded foam methods.

When a prepolymer is used in forming a polyurethane according to the practice of the invention, part or all of any of the polyols (conventional, natural oil or NOIRM) are optionally reacted with either a stoichiometric excess of at least one isocyanate to produce at least one prepolymer having isocyanate functionality or with a stoichiometric deficiency of at least one isocyanate to produce at least one polyol-terminated prepolymer. An isocyanate functional prepolymer would preferably be reacted with additional polyol, optionally admixed with at least one NOIRM, to form a polyurethane of the invention while a polyol functional prepolymer would preferably be reacted with additional isocyanate to produce a polyurethane of the invention. A polyol functional prepolymer is preferably admixed with remaining unreacted polyol, either of the same or different composition as that polyol used in preparation of the prepolymer, for reaction with the additional isocyanate. For instance, NOIRM are optionally included in the polyol component in the preparation of such PIPA copolymer polyols as those within the skill in the art and disclosed, for instance, in WO 00/73364 which is incorporated by reference herein to the extent permitted by law. When prepolymers are used, the polyol composition of the invention is considered to be the total polyol composition used in the practice of the invention is the combination of all polyols used in making the prepolymers, further reacting with the prepolymers, used with the prepolymers or separate from them in further reaction with isocyanate or a combination thereof. In each instance one or more conventional polyols, natural oil polyols, or NOIRM or a combination thereof is used in the prepolymer and the remainder of the polyol composition (including any remaining NOIRM) is used in making the final polyurethane. NOIRM is used in making the prepolymer, in a polyol composition reacted with the prepolymer or both. Optionally, several steps of reaction are used. One or more of those steps involves use of the NOIRM according to the practice of the invention.

Slabstock foam is conveniently prepared by mixing the foam ingredients and dispensing them into a trough or other region where the reaction mixture reacts, rises freely against the atmosphere (sometimes under a film or other flexible covering) and cures. In common commercial scale slabstock foam production, the foam ingredients (or various mixtures thereof) are pumped independently to a mixing head where they are mixed and dispensed onto a conveyor that is lined with paper or plastic. Foaming and curing occurs on the conveyor to form a foam bun. The resulting foams are advantageously preferably at least about 10 kg/m³, more preferably at least about 15, most preferably at least about 17 kg/m³, and independently preferably at most about 100, more preferably at most about 90, most preferably at most about 80 kg/m³ in density.

A preferred slabstock foam formulation contains preferably at least about 1, more preferably at least about 1.2, and preferably at most about 6, more preferably at most about 5 parts by weight water are used per 100 parts by weight high equivalent weight polyol at atmospheric pressure. At reduced pressure these levels are optionally reduced. On another hand, if pressure is increased, these water levels sometimes need to be increased.

High resilience slabstock (HR slabstock) foam is made in methods similar to those used to make conventional slabstock foam but using higher equivalent weight polyols. HR slabstock foams are characterized in exhibiting a ball rebound score of at least 40 percent measured according to the procedures of ASTM 3574.93. Water levels tend to be from about 2 to about 6, especially from about 3 to about 5 parts per 100 parts by weight of polyols. In contrast, viscoelastic foams often contain lower equivalent weight polyols and have ball rebound values below 25 percent as measured according to the procedure of ASTM 3574.93. Water levels tend to be from about 1 to about 3, especially from about 1.1 to about 2.5 parts by weight of polyol.

Molded foam can be made according to the invention by transferring the reactants (polyol composition, polyisocyanate, blowing agent, and surfactant) to a closed mold where the foaming reaction takes place to produce a shaped foam. Either a so-called “cold-molding” process, in which the mold is not preheated significantly above ambient temperatures, or a “hot-molding” process, in which the mold is heated to drive the cure, are optionally used. Cold-molding processes are preferred to produce high resilience molded foam, that is, foam having resiliency above about 40 percent using the ball rebound test. Densities for molded foams often range from 30 to 80 kg/m³.

The applications for foams produced by the present invention are those known in the art or within the skill in the art. For instance, flexible, semi-rigid and viscoelastic foams find use in applications such as bedding, furniture, shoe innersoles, automobile seats, sun visors, packaging applications, armrests, door panels, noise insulation parts, other cushioning and energy management applications, dashboards and other applications for which conventional flexible polyurethane foams are used, as described in “Polyurethane Handbook” by G. Oertel et al, Hanser publisher.

Addition of the NOIRM to the formulations used to make polyurethane foams according to the practice of the invention uses the NOIRM materials that were previously not recognized to be useful. Furthermore, such addition of NOIRM increases the renewable resource content or level of polyurethane products to reduce petroleum dependency. Preferably, addition of the NOIRM also improves at least one physical property of a polyurethane product produced using them as compared with the same product produced using the same process and formulation except without the molecules of renewable resource origin having an average of fewer than 1.5 isocyanate reactive groups. For instance, more open cells are frequently observed in a foam made with NOIRM than without NOIRM.

Objects and advantages of this invention are further illustrated by the following examples. The particular materials and amounts thereof, as well as other conditions and details, recited in these examples should not be used to limit this invention. Rather they are illustrative of the whole invention. Unless stated otherwise all percentages, parts and ratios are by weight. Examples of the invention are numbered while comparative samples, which are not examples of the invention, are designated alphabetically.

### EXAMPLES

The following materials are used in the examples:

PEPO-1 is a 3 functional, 2000 equivalent weight propoxylated polyether polyol with 15 percent ethylene oxide capping commercially available from The Dow Chemical Company under the trade designation Voranol CP 6001.
PEPO-2 is a 3 functional, 1630 equivalent weight polyether polyol commercially available from The Dow Chemical Company under the trade designation Voranol CP 4711.
PEPO-3 is a 60/40 blend of PEPO-4 and 1,700 equivalent weight propoxylated tetrol with 15% EO capping, initiated with 3,3′-diamino-N-methyldipropylamine commercially available from The Dow Chemical Company under the trade designation Voranol Voractiv 6340.
NOBP A is a 3-functional natural oil polyol prepared using fatty acids from soy oil and has a primary hydroxyl content of 100 percent with a hydroxyl number (OH#) of 89. It is made by reacting hydroxymethylated soybean fatty acid methyl esters with a 625 molecular weight poly(ethylene oxide) triol made by ethoxylation at 120° C. of glycerol until an equivalent weight of 209 is reached using 0.3 percent final level of KOH and finishing with synthetic magnesium silicate as known in the skill in the art and taught in such references as Polyurethane Handbook, Chemistry, Raw Materials, Processing, Application, Properties edited by G. Oertel, Hanser publisher (1993, second edition) section 3.1.1.2, at a 4:1 molar ratio, using 500 ppm of stannous octoate as the catalyst. The resulting polyether-polyester has a viscosity of 2,700 mPa·s at 21° C., a hydroxyl equivalent weight of 640, Mn of 2500, Mw of 3550, and a polydispersity of 1.44. NOBP-A has an average of approximately 3.0 hydroxyl groups/molecule. NOBP-A contains approximately 70 percent renewable resources.
NOIRM-1 is a composition of natural oil based isocyanate reactive materials obtained by the process of WO 2004/096744 and using soybean oil as the basic raw material and having the composition in Table 1. NOIRM-1 contains more than 80% renewable resources.
NOIRM-2 is hydroxymethylstearate.
NOBP-2 is castor oil obtained from Aldrich and is 100% renewable resources.
Water is deionized water.
DEOA is diethanolamine, 99 weight percent pure, obtained from Aldrich.
CAT-1 is a tertiary amine catalyst, a 33 percent solution of diethylenetriamine in 67 percent dipropylene glycol commercially available from Air Products & Chemicals, Inc. under the trade designation Dabco 33 LV
CAT-2 is a bis(dimethylaminoethyl)ether catalyst commercially available from Momentive Performance Materials under the trade designation Niax A-1.
ADD-1 is a organosilicon based surfactant commercially available from Degussa-Goldschmidt Chemical Corp. under the trade designation Tegostab B-8715LF.
ADD-2 is a cell opener commercially available from Degussa-Goldschmidt Chemical Corp. under the trade designation Tegostab B8948.
ADD-3 is a silicone surfactant commercially available from Air Products & Chemicals, Inc. under the trade designation Dabco DC 2585.
ADD-4 is a silicone surfactant commercially available from Momentive Performance Materials under the trade designation Niax L 3416.
ADD-5 is a 3 functional, 1700 equivalent weight random copolymer of 25 percent propylene oxide and 75 percent ethylene oxide commercially available from The Dow Chemical Company under the trade designation Voranol CP 1421.

### DMEA is N,N-dimethylethanolamine.

ADD-6 is 97% dipropylene glycol monomethyl ether, a petroleum based monol commercially available from The Dow Chemical Company under the trade designation Dowanol DPM.
NCO-1 is a MDI prepolymer having a weight percent NCO of 29.5 commercially available from The Dow Chemical Company under the trade designation Specflex NE 134.
NCO-2 is a polymeric MDI having a weight percent NCO of 31.5 commercially available from Bayer AG under the trade designation Desmodur 3230.
NCO-3 is toluene diisocyanate in an isomer ratio of 2,4 isomer to 2,6 isomer of 80/20 commercially available from The Dow Chemical Company under the trade designation Voranate T-80.

TABLE 1
COMPOSITION OF NOIRM-1

| COMPONENT | WEIGHT PERCENT |
|---|---|
| Methylstearate | 16.49 |
| Methylpalmitate | 10.03 |
| Hydroxymethylesters | 38.07 |
| (Monols) | |
| Dihydroxymethylesters | 28.96 |
| (Diols) | |
| Trihydroxymethylesters | 2.52 |
| (Triols) | |
| Lactols/Cyclic ethers | 1.44 |
| Lactones | 1.88 |
| dimer | 0.61 |
| total | 100.0 |
| Average Functionality | 1.01 |

In each example and comparative sample prepared according to “Process A” using the formulations given in Tables 2-5. A foam is prepared by individually weighing all of the components and additives of a given formulation including the catalysts, and weighing them into a one liter capacity cup. Component temperatures are approximately 25° C. The components are premixed for 30 seconds at 2,000 rpm using an electric driven stirrer. The isocyanates indicated in the tables are then added to the stirred components and mixed for an additional 5 seconds at 2,000 rpm. The reactants are then poured into a 30×30×10 cm aluminum mold heated at 60° C. that has been sprayed with release agent commercially available from Chem Trend under the trade designation Klueber™ 41-2038 release agent. The time when foaming mass reaches the vent holes is referred to in the tables as the mold exit time; whereas the demolding time is maintained at 4 minutes or is extended to 5 minutes if needed. Foam pads are crushed manually at demold to open cells and avoid shrinkage. Level of foam tightness is manually assessed by its resistance to crushing (more force needed to break the cells). Any other distinct reaction characteristics, such as foam odor, skin aspect are observed and recorded if they are not satisfactory. The resulting foam pads are then allowed to cure overnight under a ventilated fume hood. They are then placed in ambient storage for a period of seven days before being submitted for physical property assessment using the procedures of ASTM 3574 except as stated otherwise in the definitions of the properties.

In the tables, the amount of each component is listed in parts per hundred parts by weight of total polyol except for the isocyanates, the amount of which is given in index.

TABLE 2
EXAMPLES 1-3

| Compound or | Example Number | | |
|---|---|---|---|
| property | 1 | 2 | 3 |
| PEPO-1 | 95 | 90 | 80 |
| NOIRM-1 | 5 | 10 | 20 |
| Water | 3.5 | 3.5 | 3.5 |
| DEOA | 0.5 | 0.5 | 0.5 |
| CAT-1 | 0.4 | 0.4 | 0.4 |
| CAT-2 | 0.05 | 0.05 | 0.05 |
| ADD-1 | 1.5 | 1.5 | 1.5 |
| ADD-2 | 1.0 | 1.0 | 1.0 |
| ADD-5 | 2.0 | 2.0 | 2.0 |
| ADD-6 | | | |
| NCO-1 | 85 | 85 | 85 |
| % renewable | >4 | >8 | >16 |
| resources in | | | |
| polyol blend | | | |
| Mold exit time (s) | 78 | 75 | 74 |
| Demolding time (mi) | 4 | 4 | 4 |
| Part weight (g) | 425 | 430 | 434 |
| Comments | Open | Open | Open |
| Core density | 48.1 | 48.1 | 49.8 |
| 50% CFD (KPa) | 4.7 | 4.4 | 4.4 |
| Airflow (cfm) | 3.3 | 3.3 | 3.6 |
| Airflow converted to | 1.56 | 1.56 | 1.7 |
| l/s | | | |
| Resiliency (%) | 48 | 47 | 36 |
| 50% CS (% CD) | 8.7 | 10.6 | 20.7 |
| 75% CS (% CD) | 7.4 | 9.4 | 18.2 |
| 50% HACS (% CT) | 7.7 | 8.7 | 20.6 |
| 75% HACS (% CT) | 10.2 | 13.2 | 23.4 |

TABLE 3
COMPARATIVE SAMPLES A, B, AND C

| Compound or | Example Number | | |
|---|---|---|---|
| property | A* | B* | C* |
| PEPO-1 | 70 | 70 | 70 |
| NOBP-A | 30 | 30 | 30 |
| Water | 3.5 | 3.5 | 3.5 |
| DEOA | 0.5 | 0.5 | 0.5 |
| CAT-1 | 0.4 | 0.4 | |
| CAT-2 | 0.05 | 0.05 | 0.05 |
| ADD-1 | 0 | 1.5 | 0 |
| ADD-3 | 0.8 | | |
| ADD-4 | | 0.8 | 1.5 |
| ADD-5 | 2.0 | 2.0 | 2.0 |
| DMEA | | | 0.4 |
| NCO-1 | 85 | 85 | 85 |
| % renewable | 21 | 21 | 21 |
| resources in | | | |
| polyol blend | | | |
| Mold exit time (s) | 64 | 67 | 88 |
| Demolding time (mi) | 4 | 4 | 4 |
| Part weight (g) | 416 | 421 | 417 |
| Comments | Very tight | Very tight | Open, but |
| | | | uncured |
| Core density | NA | 46.3 | 47.6 |
| 50% CFD (KPa) | | 4.8 | 5.3 |
| Airflow (cfm) | | 3.0 | 2.5 |
| Airflow converted to | | 1.41 | 1.18 |
| l/s | | | |
| Resiliency (%) | | 47 | 48 |
| 50% CS (% CD) | | 9.4 | 9.5 |
| 75% CS (% CD) | | 8.0 | 8.7 |
| 50% HACS (% CT) | | 10.0 | 9.1 |
| 75% HACS (% CT) | | 12.7 | 13.6 |

*Comparative Samples are not examples of the invention.

TABLE 4
COMPARATIVE SAMPLES E, F AND G

| Compound or | Example Number | | |
|---|---|---|---|
| property | E* | F* | G* |
| PEPO-1 | 70 | 70 | 70 |
| NOBP-A | 30 | 30 | 30 |
| ADD-6 | | 2 | |
| Water | 3.5 | 3.5 | 3.5 |
| DEOA | 0.5 | 0.5 | 0.5 |
| CAT-1 | 0.4 | 0.4 | 0.4 |
| CAT-2 | 0.05 | 0.05 | 0.05 |
| ADD-1 | 1.5 | 1.5 | 1.5 |
| ADD-2 | 0.5 | | 2.0 |
| ADD-4 | 2.0 | 2.0 | 2.0 |
| NCO-1 | | | 85 |
| NCO-2 | 80 | 80 | |
| % renewable | 21 | 21 | 21 |
| resources in | | | |
| polyol blend | | | |
| Mold exit time (s) | 67 | 63 | 67 |
| Demolding time (mi) | 4 | 4 | 5 |
| Part weight (g) | 428 | 429 | 426 |
| Comments | open | open | Tight |
| Core density | 45.8 | 45.0 | 47.1 |
| 50% CFD (KPa) | 4.6 | 4.4 | 5.4 |
| Airflow (cfm) | 2.5 | 2.5 | 3.0 |
| Airflow converted to | 1.18 | 1.18 | 1.4 |
| l/s | | | |
| Resiliency (%) | 42 | 39 | 45 |
| 50% CS (% CD) | 16.2 | 22.3 | 11.4 |
| 75% CS (% CD) | 17.4 | 22.2 | 8.7 |
| 50% HACS (% CT) | 16.7 | 21.0 | 8.9 |
| 75% HACS (% CT) | 26.3 | 39.2 | 10.9 |

*Comparative Samples are not examples of the invention.

TABLE 5
EXAMPLES 4, 5 AND 6

| Compound or | Example Number | | |
|---|---|---|---|
| property | 4 | 5 | 6 |
| PEPO-1 | 70 | 70 | 70 |
| NOBP-A | 25 | 20 | 10 |
| NOIRM-1 | 5 | 10 | 20 |
| Water | 3.5 | 3.5 | 3.5 |
| DEOA 99% | 0.5 | 0.5 | 0.5 |
| CAT-1 | 0.4 | 0.4 | 0.4 |
| CAT-2 | 0.05 | 0.05 | 0.05 |
| ADD-1 | 1.5 | 1.5 | 1.5 |
| ADD-2 | 1.0 | 1.0 | 1.0 |
| ADD-5 | 2.0 | 2.0 | 2.0 |
| NCO-1 | 85 | 85 | 85 |
| % renewable | 21.5 | 22 | 23 |
| resources in | | | |
| polyol blend | | | |
| Mold exit time (s) | 72 | 70 | 75 |
| Demolding time (mi) | 5 | 5 | 5 |
| Part weight (g) | 426 | 428 | 435 |
| Comments | open | open | Open |
| Core density | 47.4 | 48.3 | 48.8 |
| 50% CFD (KPa) | 4.9 | 5.1 | 4.9 |
| Airflow (cfm) | 3.2 | 3.5 | 3.3 |
| Airflow converted to | 1.5 | 1.65 | 1.56 |
| l/s | | | |
| Resiliency (%) | 52 | 37 | 30 |
| 50% CS (% CD) | 12.2 | 14.6 | 27.2 |
| 75% CS (% CD) | 12.0 | 13.3 | 36.4 |
| 50% HACS (% CT) | 10.5 | 12.5 | 22.1 |
| 75% HACS (% CT) | 12.9 | 16.7 | 21.4 |

Data presented in Tables 2-5 shows that using NOBP-1 in a MDI based high resilience (HR) molded formulation results in tight foams. Incorporating NOIRM-1 monol (see composition in Table 1) having an average nominal functionality of 1.0, results in an open foam and acceptable compression sets. Increasing the level of monol used alone or combined with soy polyol (thus increasing the level of renewable resources in the polyol blend) reduces foam resiliency, thus results in viscoelastic characteristics, while maintaining desirable physical properties. Comparative examples E and F show that the use of a petroleum based monol (ADD-6) detrimentally affects foam compression sets, even at 2 PPHP.

It is believed that the NOIRM have similar effects when used in polyol compositions comprising castor oil.

Embodiments of the invention include:
1. A polyol composition comprising at least one natural oil isocyanate reactive material (NOIRM) having an isocyanate reactive functionality of less than about 1.5, preferably less than about 1.4, more preferably less than about 1.2, most preferably about 1 in an amount greater than that naturally present in any natural oil polyol in the composition.
2. A process of preparing a polyurethane comprising (a) supplying an isocyanate composition comprising at least one polyisocyanate; (b) supplying at least one polyol composition of any other embodiment; (c) admixing the isocyanate composition and the polyol composition; and (d) exposing the admixture to reaction conditions such that at least one polyurethane is formed.
3. A foam comprising the reaction product of any composition of any other embodiment and at least one isocyanate composition; the result of any process of any other embodiment; or a combination thereof.
4. An article comprising the reaction product of any composition of any other embodiment and at least one isocyanate composition; the result of any process of any other embodiment; the foam of any other embodiment or a combination thereof.
5. The composition, process, foam or article of any preceding embodiment wherein the polyol composition additionally comprises at least one natural oil polyol.
6. The composition, process, foam or article of any preceding embodiment wherein the polyol composition additionally comprises at least one conventional (petroleum based) polyol.
7. The composition, process, foam or article of any preceding embodiment wherein at least one isocyanate reactive materials of natural origin having an average functionality of preferably less than 1.5, 1.4, or 1.2, most preferably about 1, is used in combination with at least one polyol, whether it be conventional (petroleum based) polyol or natural oil polyol or a combination thereof having a functionality of at least about 1.5, 1.8 or 2.
8. The composition, process, foam or article of any preceding embodiment wherein the isocyanate index is at least about 60, 70, 80, or 90 optionally to at most about 150, 130, 120, 115, or 110.
9. The composition, process, foam or article of any preceding embodiment wherein the conventional polyol is selected from poly(propylene oxide) homopolymers, random copolymers of propylene oxide and ethylene oxide in which the poly(ethylene oxide), ethylene oxide-capped poly(propylene oxide) polymers, and ethylene oxide-capped random copolymers of propylene oxide and ethylene oxide and combinations thereof.
10. The composition, process, foam or article of any preceding embodiment wherein the conventional polyol has at least about 2 and independently at most about 8, 6 or 4 predominately (greater than 50 percent) secondary (but also some primary) hydroxyl groups per molecule, preferably when the resulting foam is a slabstock foam.
11. The composition, process, foam or article of any preceding embodiment wherein the conventional polyol has an equivalent weight per hydroxyl group of from at least about 400 or 800 to at most about 3000 or 1750.
12. The composition, process, foam or article of any preceding embodiment wherein the conventional polyol has at least about 2 to about 5 or 6, preferably predominately primary hydroxyl groups per molecule and the resulting foam has a ball rebound of at least about 40.
13. The composition, process, foam or article of any preceding embodiment wherein the conventional polyol has an equivalent weight per hydroxyl group of preferably from at least about 1000 or 1200 to at most about 3000 or 2000.
14. The composition, process, foam or article of any preceding embodiment wherein the conventional polyol has a hydroxyl number above about 150, preferably wherein the resulting foam is a viscoelastic foam.
15. The composition, process, foam or article of any preceding embodiment wherein the conventional polyol has at least about 2 and independently at most about 8, 6, or 4 primary or secondary or a combination thereof hydroxyl groups per molecule.
16. The composition, process, foam or article of any preceding embodiment wherein the conventional polyol has a hydroxyl number of preferably at least about 15, 32, or 45 optionally to at most about 200, 180 or 170.
17. The composition, process, foam or article of any preceding embodiment wherein viscosity of the conventional polyol measured at 25° C. is less than about 10,000 mPa·s, preferably less than about 8,000.
18. The composition, process, foam or article of any preceding embodiment wherein the natural oil polyol is at least about 10 or 20 to at most about 60 or 40 weight percent EO.
19. The composition, process, foam or article of any preceding embodiment wherein the natural oil polyol includes or, preferably is at least one initiated fatty acid polyester alcohol.
20. The composition, process, foam or article of any preceding embodiment wherein the natural oil polyol is initiated with alkoxylated, preferably ethoxylated, polyhydroxyl compounds, preferably glycerin, sucrose, or combinations thereof.
21. The composition, process, foam or article of any preceding embodiment wherein the natural oil polyol has a molecular weight of at least about 400 or 600 to at most about 1000 or 800.
22. The composition, process, foam or article of any preceding embodiment wherein the natural oil polyol includes, or preferably is, at least one initiated secondary hydroxyl fatty acid copolyester.
23. The composition, process, foam or article of any preceding embodiment wherein initiator has a molecular portion derived from ethylene oxide or a mixture of ethylene and at least one other alkylene oxide and preferably has a molecular weight of 200, 400 or 500 to 6000, 2000 or 1000.
24. The composition, process, foam or article of any preceding embodiment wherein at least one natural oil polyol preferably contains at least about 10, 15, or 20 to at most about 60, 50 or 40 weight percent moieties derived from ethylene oxide.
25. The composition, process, foam or article of any preceding embodiment wherein the functionality of the natural oil polyol, or blend of such polyols, is at least about 1.5, 1.8 or 2.0 to at most about 6, 5 or 4.
26. The composition, process, foam or article of any preceding embodiment wherein The hydroxyl number of at least one natural oil polyol, or blend of such polyols, is preferably at most about 300, 200 or 100 mg KOH/g.
27. The composition, process, foam or article of any preceding embodiment wherein the viscosity of the natural oil polyol measured at 25° C. is less than about 10,000 mPa·s, preferably less than about 8,000 mPa·s.
28. The composition, process, foam or article of any preceding embodiment wherein the natural oil polyol component comprises at least two different natural oil polyols wherein the differences are in at least one of (a) processes by which they are made, (b) structural differences sufficient to result in improved physical or processing properties, satisfactory properties at a higher level of renewable resources or when using a larger amount of combined natural oil polyols in a resulting polymeric product or a combination thereof, all as compared with essentially the same end product produced by essentially the same process but using one of the natural oil polyols alone in an amount equal to that of the combination of natural oil polyols.
29. The composition, process, foam or article of any preceding embodiment wherein the processes by which the two or more natural oil polyols were prepared differ by at least one of reaction temperature, reaction time, reaction pressure or a combination thereof, preferably by more than one of reaction temperature, reaction time, reaction pressure, catalyst, at least, more preferably by at least one unit operation, or a combination thereof.
30. The composition, process, foam or article of any preceding embodiment wherein at least one first natural oil polyol is prepared by a first process and at least one second natural oil polyol is prepared by a second process and the first process involves at least one unit operation of hydroformylation, epoxidation, alkoxylation, esterification, transesterification, alcoholysis, oxidation, ring opening using a natural oil or derivative thereof while the second process does not involve at least one of the listed unit operations used in preparing the first polyol or involves at least one additional unit operation or, a combination of both.
31. The composition, process, foam or article of any preceding embodiment wherein at least two natural oil polyols represent different members of the group consisting of triethanolamine alcoholyzed peroxy acid hydroxylate, epoxidized vegetable oil at least partially ring opened to produce a secondary hydroxyl group on a main vegetable oil chain, hydroformylated vegetable oil where the formyl groups have been at least partially converted to hydroxymethyl groups; air blown vegetable oil (not alkoxylated or further treated), alkoxylated air blown vegetable oil, transesterified air blown oil; fatty acid alcohol alkoxylates; transesterified vegetable oil, alkoxylated vegetable oil; alkoxylated polyester polyol, polyester polyol, polyetherpolyester polyol, initiated fatty acid polyester alcohol; epoxy ring-opening oligomer, and natural polyol.
32. The composition, process, foam or article of any preceding embodiment wherein the two polyols independently differ by at least one of the following: percentage of hydroxyl groups that are primary as compared to secondary; hydroxyl functionality; molecular weight; hydrophilicity (level of ethylene oxide); or natural oil raw material.
33. The composition, process, foam or article of any preceding embodiment wherein (a) at least one of the different natural oil polyols has at least about 50, percent of its hydroxyl groups as primary while at least one different natural oil polyol has at least about 51, percent of its hydroxyl groups as secondary; (b) the polyols differ in hydroxyl functionality by at least about 10 percent; (c) have molecular weights differing by at least about 10 percent; (d) differ in hydrophilicity, by at least about 10 percent in level of ethylene oxide incorporated into the polyol molecules; (e) differ in originating from different natural oil raw materials, (f) differ in having a difference in fatty acid distribution as reflected in at least about a 10 weight percent difference in the level of any fatty acid or ester; or a combination thereof.
34. The composition, process, foam or article of any preceding embodiment wherein at least one of the natural oil polyols is at least one initiated fatty acid polyester alcohol.
35. The composition, process, foam or article of any preceding embodiment wherein at least one natural oil polyol has been oxidized or epoxidized in some stage of its preparation.
36. The composition, process, foam or article of any preceding embodiment wherein at least one of the different natural oil polyols is an initiated fatty acid polyester alcohol, while at least one different natural oil polyol has been oxidized or epoxidized.
37. The composition, process, foam or article of any preceding embodiment wherein each NOIRM is selected from an individual compound from or derived from a natural oil; a mixture of compounds of natural origin; a mixture of purified monols extracted or otherwise concentrated from such a mixture; and a polymer made from compositions comprising any of the preceding types of NOIRM; or a combination thereof.
38. The composition, process, foam or article of any preceding embodiment wherein at least one NOIRM or, preferably each NOIRM, is obtained by a process that includes saponification of at least one natural oil.
39. The composition, process, foam or article of any preceding embodiment wherein each NOIRM has an average molecular weight of at least about 100, 200 or 250 to at most about 1,500, 1,200 or 1,000 or when the NOIRM is a mixture, each component of the mixture has a molecular weight of preferably at least about 100, 200 or 250 to at most about 1,500, 1,200 or 1,000.
40. The composition, process, foam or article of any preceding embodiment wherein each NOIRM has an average isocyanate reactive equivalent weight of at least about 100, 200 or 240, to at most about 1,500, 1,200, 1,000.
41. The composition, process, foam or article of any preceding embodiment wherein at least one NOIRM is used with at least one polyol to react with at least one isocyanate to form a polyurethane.
42. The composition, process, foam or article of any preceding embodiment wherein the amount of NOIRM is at least about 1, 2, 3, 4, or 5 and at most about 60, 50, 40, or 30 parts per hundred parts by weight of total polyol where the NOIRM is counted as part of the polyol composition.
43. The composition, process, foam or article of any preceding embodiment wherein the amount of conventional polyol or a combination thereof is in an amount of 0 weight percent, or of at least about 10, 15 or 20 to at most about 90, 80, or 70 PPHP.
44. The composition, process, foam or article of any preceding embodiment wherein the natural oil polyol or combination thereof constitutes from 0, 2, 5, 10, 15, 20 to at most about 99, 95, 92, 90 weight percent or PPHP of polyol formulation.
45. The composition, process, foam or article of any preceding embodiment wherein water is present in an amount of at least about 0.5 or 2, to at most about 10 or 7 PPHP.
46. The composition, process, foam or article of any preceding embodiment wherein the polyol composition additionally comprises at least one monol of petroleum origin having an average molecular weight of at least about 100, 200 or 250 to at most about 1,500, 1,200 or 1,000.
47. The composition, process, foam or article of any preceding embodiment wherein part of the natural oil polyol is a natural oil, preferably castor oil, more preferably where castor oil is the only natural oil polyol used; in one embodiment most preferably where castor oil is used with at least one conventional polyol; in another embodiment most preferably where castor oil is used in the substantial absence of conventional polyol.
48. The composition, process, foam or article of any preceding embodiment wherein part or all of any of the polyols (conventional, natural oil or NOIRM) are reacted with either a stoichiometric excess of at least one isocyanate to produce at least one prepolymer having isocyanate functionality or with a stoichiometric deficiency of at least one isocyanate to produce at least one polyol-terminated prepolymer.
49. The composition, process, foam or article of any preceding embodiment wherein at least one resulting foam has a density at least about 10, 15, or 17 kg/m³, and independently to at most about 100, 90, or 80 kg/m³ in density.
50. The composition, process, foam or article of any preceding embodiment wherein the amount of water is at least about 1 or 1.2 to at most about 6 or 5 PPHP used at atmospheric pressure.
51. The composition, process, foam or article of any preceding embodiment wherein water is present in an amount of at least about 2 or 3 to about 5 or 6 PPHP and the resulting foam exhibits a ball rebound of at least 40 percent measured according to the procedures of ASTM 3574.93.
52. The composition, process, foam or article of any preceding embodiment wherein water is present in an amount of at least about 1 or 1.1 to about 2.5 or 3 PPHP and the resulting foam exhibits a ball rebound of at most 25 percent measured according to the procedures of ASTM 3574.93.
53. The composition, process, foam or article of any preceding embodiment wherein the foam has a density of from 30 to 50 or 80 kg/m³ and the resulting foam exhibits a ball rebound of at least 40 percent measured according to the procedures of ASTM 3574.93.
54. The composition, process, foam or article of any preceding embodiment wherein addition of at least one NOIRM improves at least one physical property of a polyurethane product produced using it as compared with the same product produced using the same process and formulation except without the NOIRM.
55. The composition, process, foam or article of any preceding embodiment wherein the foam, foam formed from the composition or by the process or a combination thereof is more open as measured by airflow than is a foam obtained in the same formulation without the NOIRM.
56. The composition, process, foam or article of any preceding embodiment wherein the foam, foam formed from the composition or by the process or a combination thereof has a higher level of renewable content than has a foam obtained in the same formulation without the NOIRM.
57. The composition, process, foam or article of any preceding embodiment wherein the foam or resulting foam is used in bedding, furniture, shoe innersoles, automobile seats, sun visors, packaging applications, armrests, door panels, noise insulation parts, other cushioning or energy management applications, dashboards or a combination thereof.
58. The article of any preceding embodiment comprising at least one bedding, furniture, shoe innersole, automobile seat, sun visor, packaging application, armrest, door panel, noise insulation part, other cushioning or energy management application, dashboard or a combination or part thereof.

1. A polyol composition comprising at least one polyol having a functionality of greater than 1.5.and at least one natural oil isocyanate reactive material (NOIRM) having an isocyanate reactive functionality of less than about 1.5, with the proviso that if the polyol composition further comprises a natural oil polyol the at least one NORIM is present in the polyol composition in an amount greater than that would naturally be present in the natural oil polyol in the composition.

2. The composition of claim 1 wherein the NOIRM has an average functionality of less than about 1.4.

3. The composition of claim 1 wherein polyol or combination thereof has an average functionality of at least about 1.8 and at most about 8.

4. The composition of claim 1 wherein at least one polyol comprises molecular moieties derived from ethylene oxide of at least about 10 to at most about 60 weight percent.

5. The composition of claim 1 wherein the natural oil polyol includes at least one initiated fatty acid polyester alcohol.

6. The composition of claim 1 wherein the natural oil polyol includes at least one initiated secondary hydroxyl fatty acid copolyester.

7. The composition of claim 1 wherein the natural oil polyol component comprises at least two different natural oil polyols wherein the differences are in at least one of (a) processes by which they are made, or (b) structural differences sufficient to result in improved physical or processing properties, satisfactory properties at a higher level of renewable resources or when using a larger amount of combined natural oil polyols in a resulting polymeric product or a combination thereof, all as compared with essentially the same end product produced by essentially the same process but using one of the natural oil polyols alone in an amount equal to that of the combination of natural oil polyols.

8. The composition of claim 1 wherein at least one natural oil polyol has been oxidized or epoxidized in some stage of its preparation.

9. The composition of claim 1 wherein each NOIRM is selected from an individual compound from or derived from a natural oil; a mixture of compounds of natural origin; a mixture of purified monols extracted or otherwise concentrated from such a mixture; and a polymer made by reacting any of these types of monols; or a combination thereof.

10. The composition of claims 1-9 wherein each NOIRM is obtained by a process that includes saponification of at least one natural oil.

11. The composition of claim 1 wherein each NOIRM has an average molecular weight of at least about 100 to at most about 1,500.

12. The composition of claim 1 wherein the amount of NOIRM is at least about 1 and at most about 60 parts per hundred parts by weight of total polyol composition where the NOIRM is counted as part of the polyol composition; the amount of conventional polyol or a combination thereof is in an amount of at least about 10 to at most about 90 PPHP; and the amount of natural oil polyol or combination thereof is from 2 to at most about 99 PPHP of the polyol composition.

13. A process of preparing a polyurethane comprising (a) supplying an isocyanate composition comprising at least one polyisocyanate; (b) supplying at least one polyol composition comprising at least one natural oil isocyanate reactive material (NOIRM) having an isocyanate reactive functionality of less than about 1.5, with the proviso that if the polyol composition further comprises a natural oil polyol the at least one NORIM is present in the polyol composition in an amount greater than that would naturally be present in the natural oil polyol in the composition; (c) admixing the isocyanate composition and the polyol composition; and (d) exposing the admixture to reaction conditions such that at least one polyurethane is formed.

14. (canceled)

15. A foam comprising the reaction product of any polyol composition comprising at least one natural oil isocyanate reactive material (NOIRM) having an isocyanate reactive functionality of less than about 1.5, with the proviso that if the polyol composition further comprises a natural oil polyol the at least one NORIM is present in the polyol composition in an amount greater than that would naturally be present in the natural oil polyol in the composition, and at least one isocyanate composition.

16. (canceled)

17. An article comprising a foam of claim 15.

18. The article of claim 17 comprising at least one bedding, furniture, shoe innersole, automobile seat, sun visor, packaging application, armrest, door panel, noise insulation part, other cushioning or energy management application, dashboard or a combination or part thereof.
